(19) United States
(12) Patent Application Publication
(10) Pub. No.: US 2007/0214233 A1
(43) Pub. Date: Sep. 13, 2007

(54) System and method for implementing a hypervisor for server emulation

(76) Inventors: Daryl Cromer, Cary, NC (US); Howard J. Locker, Cary, NC (US); Randall S. Springfield, Chapel Hill, NC (US); Rod D. Waltermann, Rougemont, NC (US)

Correspondence Address: DILLION & YUDELL LLP, 8911 N. CAPITAL OF TEXAS HWY, SUITE 2110, AUSTIN, TX, 78759, US

(21) Appl. No.: 11/369,930

(22) Filed: Mar. 7, 2006

(51) Int. Cl. G06F 15/16; G06F 15/173

(52) U.S. Cl. 709/217; 709/223

(57) ABSTRACT

A method, system, and computer-usable medium for implementing a cluster network including a collection of clients that further include a client operating system and a server operating system, wherein the server operating system caches data retrieved from the cluster network from prior successful access to the cluster network, removing at least one client among the collection of clients from the cluster network, and in response to detecting the removal of at least one client from the cluster network, intercepting and re-routing at least one request targeted to the cluster network to the server operating system, wherein the server operating system emulates the cluster network by providing at least one response to the at least one request from the at least one client to the cluster network utilizing the cached data.

### BACKGROUND OF THE INVENTION

1. Technical Field

The present invention relates in general to the field of data processing systems, and in particular, the present invention relates to the field of networked data processing systems. Still more particularly, the present invention relates to a system and method for implementing a hypervisor for server emulation.

2. Description of the Related Art

With the proliferation of low-cost, high-speed Internet connections and economical portable computing devices, today's corporate employee may spend more time away from the office network. Typically, a corporate employee may take work out of the office on a laptop computer. When a system leaves the corporate network, the startup procedures default to a local-authentication policy, since the corporate domain login procedure is not available. Utilizing the local-authentication policy leaves some resources inaccessible and the system easily compromised if the system is coupled to an unsecured network.

Therefore, there is a need for a system and method to address the abovementioned limitations.

### SUMMARY OF THE INVENTION

The present invention includes, but is not limited to, a method, system, and computer-usable medium for implementing a cluster network including a collection of clients that further include a client operating system and a server operating system, wherein the server operating system caches data retrieved from the cluster network from prior successful access to the cluster network, removing at least one client among the collection of clients from the cluster network, and in response to detecting the removal of at least one client from the cluster network, intercepting and re-routing at least one request targeted to the cluster network to the server operating system, wherein the server operating system emulates the cluster network by providing at least one response to the at least one request from the at least one client to the cluster network utilizing the cached data.

The above, as well as additional purposes, features, and advantages of the present invention will become apparent in the following detailed written description.

### BRIEF DESCRIPTION OF THE FIGURES

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying figures, wherein:

FIG. 1 is a block diagram illustrating an exemplary cluster network in which a preferred embodiment of the present invention may be implemented;

FIG. 2 is a block diagram depicting an exemplary data processing system in which a preferred embodiment of the present invention may be implemented;

FIG. 3 is a block diagram illustrating exemplary contents of system memory 206 as depicted in FIG. 2 according to a preferred embodiment of the present invention; and

FIG. 4A is a high-level logical flowchart diagram depicting an exemplary method of implementing a hypervisor for server emulation according to a preferred embodiment of the present invention;

FIG. 4B is a high-level logical flowchart diagram illustrating an exemplary method of disconnecting a client from a cluster network according to a preferred embodiment of the present invention; and

FIG. 4C is a high-level logical flowchart diagram depicting an exemplary method of incorporating a client into a cluster network according to a preferred embodiment of the present invention.

### DETAILED DESCRIPTION OF A PREFERRED EMBODIMENT

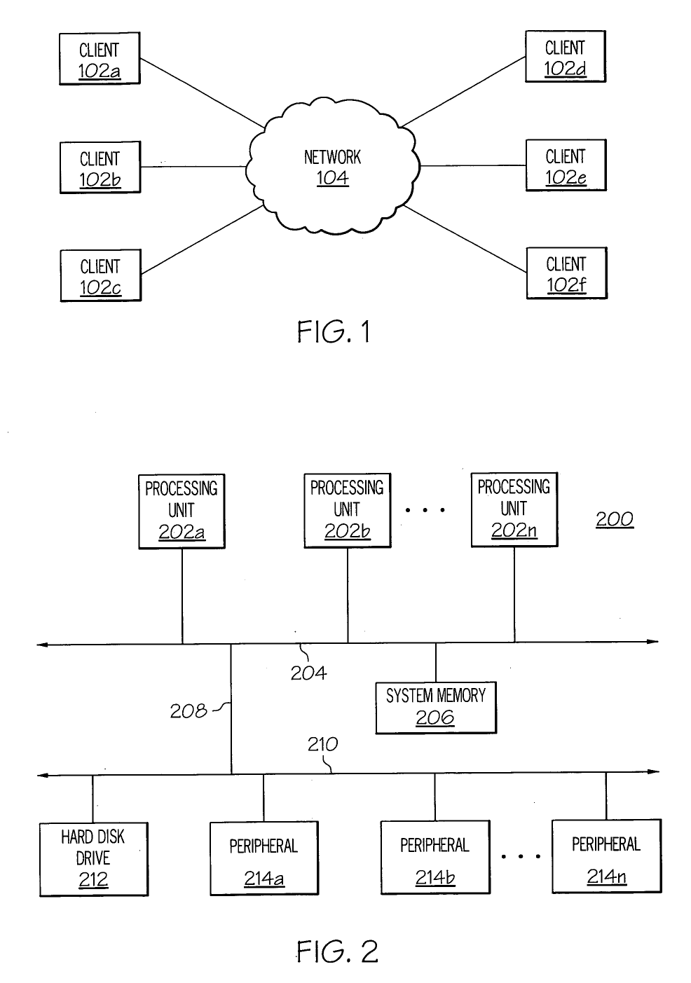

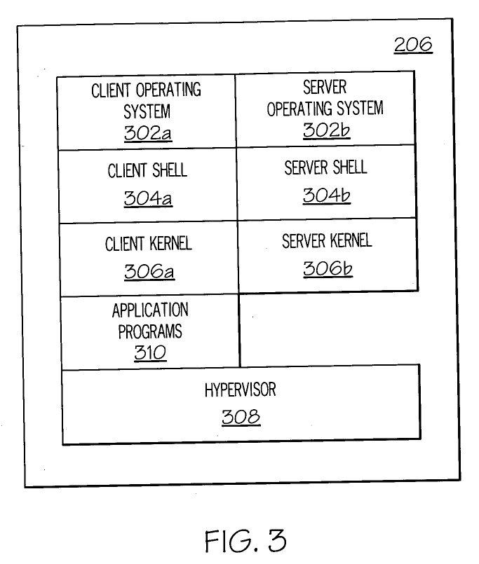

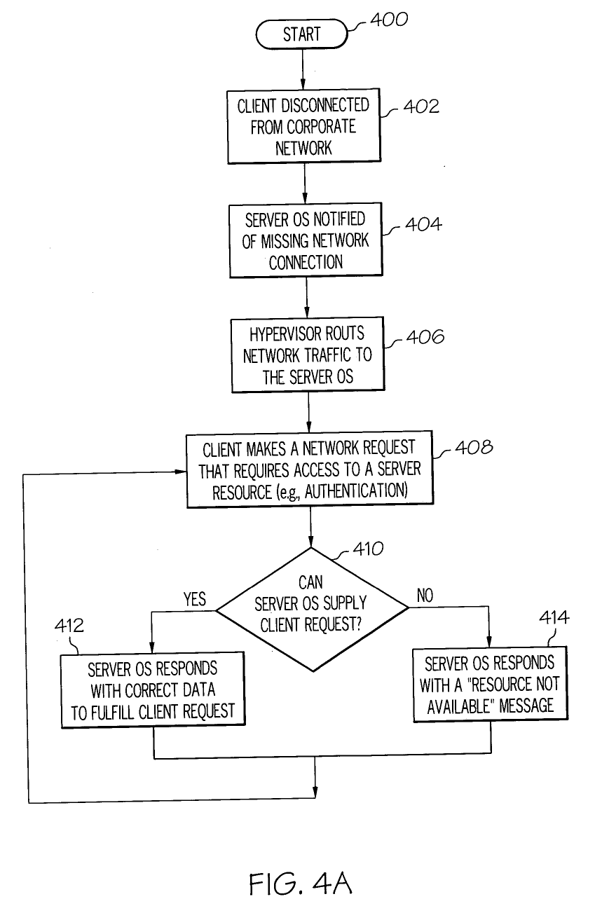

Referring now to the figures, and in particular, referring to FIG. 1, there is a block diagram illustrating an exemplary cluster network 100 in which a preferred embodiment of the present invention may be implemented. As depicted, exemplary cluster network 100 includes a collection of clients 102a-f which collectively emulate a central server via a server operating system 302b (see FIG. 3) stored in system memory 206 (see FIG. 2) of each client 102a-f. During the routine operation of cluster network 100, each of clients 102a-f cache information stored in the other clients in the cluster. When one of clients 102a-f leave cluster network 100, the remaining server operating systems 302b store in the remaining clients 102a-f negotiate to fill-in for the tasks formerly performed by the missing client utilizing data cached from the missing client. Also, as illustrated, clients 102a-f are coupled by network 104, which may be implemented by a local-area network (LAN), wide-area network (WAN), or any other type of network. Those with skill in the art will appreciate that clients 102a-f may be coupled by Ethernet, wireless (e.g., IEEE 802.11x), or any other type of connection to cluster network 100. Also, those with skill in the art will appreciate that cluster network 100 may be implemented by any number of clients and the present invention is in no way limited to the six clients (clients 102a-f) illustrated in FIG. 1.

Those skilled in the art will appreciate that network 100 can include many additional components not specifically illustrated in FIG. 1. Because such additional components are not necessary for an understanding of the present invention, they are not illustrated in FIG. 1 or discussed further herein.

FIG. 2 is a block diagram depicting an exemplary data processing system 200 (which may be utilized to implement clients 102a-f illustrated in FIG. 1) in which a preferred embodiment of the present invention may be implemented. As illustrated, data processing system 200 includes a collection of processing units 202a-n which are coupled by system interconnect 204. Also coupled to processing units 202a-n via system interconnect 204 is system memory 206, discussed herein in more detail in conjunction with FIG. 3. Mezzanine interconnect 208 couples system interconnect 204 with peripheral interconnect 210.

Those with skill in this art will appreciate that peripheral bus 210 may be implemented as a peripheral component interconnect (PCI), accelerated graphics port (AGP), or any other peripheral bus. Coupled to peripheral bus 210 is hard disk drive 210, which is utilized by data processing system 200 as a mass storage device. Also coupled to peripheral bus 210 is a collection of peripherals 214a-n.

Those skilled in the art will appreciate that data processing system 200 can include many additional components not specifically illustrated in FIG. 2. Because such additional components are not necessary for an understanding of the present invention, they are not illustrated in FIG. 2 or discussed further herein. It should also be understood, however, that the enhancements to data processing system 200 for utilizing a hypervisor for server emulation provided by the present invention are applicable to data processing systems of any system architecture and are in no way limited to the generalized multi-processor architecture or symmetric multi-processing (SMP) architecture illustrated in FIG. 2.

FIG. 3 is a block diagram illustrating exemplary contents of system memory 206 depicted in FIG. 2 according to a preferred embodiment of the present invention. As depicted, system memory 206 includes client operating system 302a, server operating system 302b, client shell 304a, server shell 304b, client kernel 306a, server kernel 306b, hypervisor 308, and application programs 310.

Client operating system 302a further includes client shell 304a which provides transparent user access to resource such as application programs 310. Generally, client shell 304a is a program that provide an interpreter and an interface between the user and the operating system. More specifically, client shell 304a executes commands that are entered into a command line user interface or a file. Thus, client shell 304a and server shell 304b (as they are called in UNIX®), also called command processors in Windows®, are generally the highest level of the operating system software hierarchy and serve as command interpreters. The shell provides a system prompt, interprets commands entered by keyboard, mouse, or other user input media, and sends the interpreted command(s) to the appropriate lower levels of the operating system (e.g., client kernel 306a and server kernel 306b) for processing. Note that while client shell 304a and server shell 304b are text-based, line-oriented user interfaces, the present invention will support other user interface modes, such as graphical, voice, gestural, etc. equally well.

As illustrated, client operating system 302a and server operating system 302b also include client kernel 306a and server kernel 306b, which include lower levels of functionality for client operating system 302a and server operating system 302b, including providing essential services required by other parts of client operating system 302a and server operating system 302b and application programs 310, including memory management, process and task management, disk management, and mouse and keyboard management. Hypervisor 308 is preferably implemented as a small virtualization machine monitor (VMM) capable of running both client operating system 302a and server operating system 302b concurrently on data processing system 200. Application programs 310 can include a browser, utilized for access to the Internet, word processors, spreadsheets, and other application programs.

Server operating system 302b, as discussed above, interacts with server operating systems stored on other clients in the network to collectively emulate a central server. Server operating system 302b preferably performs as a domain controller, global catalog server, domain name server (DNS), dynamic host configuration protocol (DHCP) server, lightweight directory access protocol (LDAP) server, and handles distributed file sharing. Those with skill in the art will appreciate that server operating system 302b is not limited to the above-mentioned tasks.

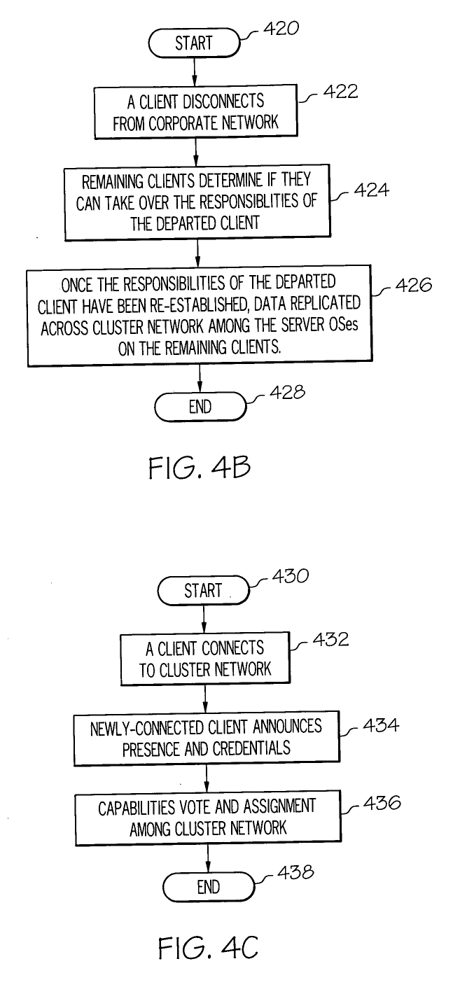

FIG. 4A is a high-level logical flowchart diagram illustrating an exemplary method of implementing a hypervisor as server emulation according to a preferred embodiment of the present invention.

The process begins at step 400 and proceeds to step 402, which illustrates disconnecting one of clients 102a-f (e.g., client 102a) from the corporate network implemented by cluster server 100. Server operating system 302b, stored in system memory 206, detects the missing connection to cluster server 100, as depicted in step 404. Then, as illustrated by step 406, hypervisor 308 routs requests from client 102a intended for cluster network 100 to be addressed by server operating system 302b. The process proceeds to step 408, which illustrates client 102a making a request that requires access to a cluster network 100 resource (e.g., authentication of a user logging on to the network). Server operating system 302b determines whether it can supply the required response to the client request, as depicted in step 410. If server operating system 302a can supply the required response, the process proceeds to step 412, which illustrates server operating system 412 responding with the required data to fulfill the client request. However, if server operating system 302b cannot supply the required response, the process proceeds to step 414, which illustrates server operating system 302b responding to the client request with a “resource not available message”. The process returns to step 408 and proceeds in an iterative fashion.

One example of implementing a hypervisor for server emulation includes utilizing cached data from a prior successful authentication or login process to authenticate a user once the client has been removed from the cluster network. When the client has been removed from the cluster network, on startup, the client will attempt to communicate with the cluster network or specifically, the cluster network LDAP server. The hypervisor will intercept the authentication request and re-route the request to the server operating system, which will take over performing the LDAP functions utilizing the last cached policy information replicated from the cluster network LDAP server. Additionally, the system operating system can perform other functions such as DNS caching, when the client is disconnected from the network.

FIG. 4B is a high-level flowchart diagram depicting an exemplary method of disconnecting a client 102a-f (e.g., client 102a) from cluster network 100 according to a preferred embodiment of the present invention. The process begins at step 420 and proceeds to step 422, which illustrates client 102a disconnecting from cluster network 100. The process continues to step 424, which depicts the remaining clients in cluster network 100 determining if they can take over the responsibilities for the departed client 102a. Once the responsibilities of departed client 102a have been re-allocated to the remaining clients, the data associated with those responsibilities are replicated across cluster network 100, as illustrated in step 426. The process then ends, as depicted in step 428.

FIG. 4C illustrates an exemplary method of incorporating a client (e.g., client 102a) to cluster network 100 according to a preferred embodiment of the present invention. The process begins at step 430 and proceeds to step 432, which illustrates client 102a connecting to cluster network 100. Newly-connected client 102a announces its presence and credentials to cluster network 100, as depicted in step 434. The process proceeds to step 436, which depicts clients 102a-f voting and assigning tasks among cluster network 100. The voting and assigning process is described herein in more detail. The process then ends, as illustrated in step 438.

In a preferred embodiment of the present invention, when a client (e.g., client 102a) connects to cluster network 100, client 102a announces its presence and credentials to cluster network 100, as previously described. The credentials are verified by the current cluster members. If client 102a is being connected for the first time, the credentials must be added to the cluster prior to client 102a's connection. Once client 102a is verified, a capabilities vote takes place among the cluster members. Each client 102a-f's server operating system 302b reviews its cached data, assesses what server capabilities the particular client can perform, and calculates its average and total time coupled to cluster network 100. Each server operating system 302b within cluster network 100 exchange the assessed capabilities and takes a capabilities vote.

Clients 102a-f then create a capability score array, and zeros out each entry within the array. Then, each client 102a-f performs the following two-pass voting method:

For each set of capabilities, each capability is assessed by determining if each client 102a-f has this specific capability. If a particular client has this specific capability, it receives a higher capability score than a client that does not. If the clients within the cluster all have a specific capability, other criteria (e.g., average and total time coupled to cluster network 100) is utilized to determine capability score.

As discussed, the present invention includes, but is not limited to, a method, system, and computer-usable medium for implementing a cluster network including a collection of clients that further include a client operating system and a server operating system, wherein the server operating system caches data retrieved from the cluster network from prior successful access to the cluster network, removing at least one client among the collection of clients from the cluster network, and in response to detecting the removal of at least one client from the cluster network, intercepting and re-routing at least one request targeted to the cluster network to the server operating system, wherein the server operating system emulates the cluster network by providing at least one response to the at least one request from the at least one client to the cluster network utilizing the cached data.

It should be understood that at least some aspects of the present invention may alternatively be implemented in a computer-usable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as but not limited to Random Access Memory (RAM), and communication media, such as computer and telephone networks including Ethernet, the Internet, wireless networks, and like network systems. It should be understood, therefore, in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A method comprising:
implementing a cluster network including a plurality of clients that further include a client operating system and a server operating system, wherein said server operating system caches data retrieved from said cluster network from prior successful accesses to said cluster network;
removing at least one client among said plurality of clients from said cluster network; and
in response to detecting said removing, intercepting and re-routing at least one request targeted to said cluster network to said server operating system stored in said at least one removed client, wherein said server operating system emulates said cluster network by providing at least one response to said at least one request from said at least one client to said cluster network utilizing said cached data.

2. The method according to claim 1, further comprising:
in response to determining said at least one request cannot be completed, indicating that a resource utilized to complete said at least one request is not available.

3. The method according to claim 1, further comprising:
in response to detecting said removing, re-assigning to said plurality of clients functions previously performed by said at least one client removed from said cluster network.

4. The method according to claim 1, further comprising:
re-establishing connection between said at least one client and said cluster network;
announcing presence and credentials of said at least one client to said cluster network; and
re-distributing tasks among said cluster network to accommodate presence of said at least one client.

5. A system comprising:
a processing unit;
a data bus coupled to said processing unit;
a memory coupled to said data bus; and
a computer-readable medium embodying computer program code, said computer program code comprising instructions executable by said processor and configured for:
implementing a cluster network including a plurality of clients that further include a client operating system and a server operating system, wherein said server operating system caches data retrieved from said cluster network from prior successful accesses to said cluster network;
removing at least one client among said plurality of clients from said cluster network; and
in response to detecting said removing, intercepting and re-routing at least one request targeted to said cluster network to said server operating system stored in said at least one removed client, wherein said server operating system emulates said cluster network by providing at least one response to said at least one request from said at least one client to said cluster network utilizing said cached data.

6. The system according to claim 5, wherein said instructions are further configured for:
in response to determining said at least one request cannot be completed, indicating that a resource utilized to complete said at least one request is not available.

7. The system according to claim 5, wherein said instructions are further configured for:
in response to detecting said removing, re-assigning to said plurality of clients functions previously performed by said at least one client removed from said cluster network.

8. The system according to claim 5, wherein said instructions are further configured for:
re-establishing connection between said at least one client and said cluster network;
announcing presence and credentials of said at least one client to said cluster network; and
re-distributing tasks among said cluster network to accommodate presence of said at least one client.

9. A computer-usable medium embodying computer program code, said computer program code comprising computer-executable instructions configured for:
implementing a cluster network including a plurality of clients that further include a client operating system and a server operating system, wherein said server operating system caches data retrieved from said cluster network from prior successful accesses to said cluster network; and
removing at least one client among said plurality of clients from said cluster network;
in response to detecting said removing, intercepting and re-routing at least one request targeted to said cluster network to said server operating system stored in said at least one removed client, wherein said server operating system emulates said cluster network by providing at least one response to said at least one request from said at least one client to said cluster network utilizing said cached data.

10. The computer-usable medium according to claim 9, wherein said embodied computer program code further comprises computer-executable instructions configured for:
in response to determining said at least one request cannot be completed, indicating that a resource utilized to complete said at least one request is not available.

11. The computer-usable medium according to claim 9, wherein said embodied computer program code further comprises computer-executable instructions configured for:
in response to detecting said removing, re-assigning to said plurality of clients functions previously performed by said at least one client removed from said cluster network.

12. The computer-usable medium according to claim 9, wherein said embodied computer program code further comprises computer-executable instructions configured for:
re-establishing connection between said at least one client and said cluster network;
announcing presence and credentials of said at least one client to said cluster network; and
re-distributing tasks among said cluster network to accommodate presence of said at least one client.
